(19) United States
(12) Patent Application Publication
(10) Pub. No.: US 2004/0169061 A1
(43) Pub. Date: Sep. 2, 2004

(54) Welding accessory for welding pipes

(76) Inventor: Jan Schepers, Hoogeveen (NL)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 10/470,009

(22) PCT Filed: Jan. 10, 2002
(86) PCT No.: PCT/NL02/00013

(30) Foreign Application Priority Data
Jan. 23, 2001 (NL) 1017172

(51) Int. Cl. B23K 37/00

(52) U.S. Cl. 228/44.5; 228/49.3

(57) ABSTRACT

The invention relates to a welding accessory (1) to support and centre two pipe ends (2a, 2b) to be butt-welded. The welding accessory (1) comprises a central guide frame, (3, 4, 5a-d), over which the two pipes ends (2a, 2b) can be slid, provided with supports (13a-d, 16a-d) and with pressure means, for pressing the supports against the pipes walls. The supports (13a-d) have a triangular or trapezial shape and have a radius of curvature of the pipes. The space between the supports (13a-d) is filled by auxiliary supports (16a-d), also having a triangular or trapezial shape, which are pulled in place by springs (18a-d).

The invention relates to a welding accessory for supporting and centring two pipe ends of pipes to be butt-welded together, comprising a central guide frame, over which both pipe ends can slide, provided with support means and with pressure means for operationally pressing the support means against the pipe walls.

A welding accessory of this type is known from patent application EP-A-0 395 370. This known welding accessory contains a system of substantially united ceramic pieces, embedded in two heat-resistant silicone rubber mouldings. In the mouldings annular compartments are made that can be evacuated, as a result of which the ceramic pieces are pulled against the pipes inner walls. For that purpose, the known welding accessory is provided with a vacuum nipple. A disadvantage of the known apparatus is that the construction is not very rigid and that after being welded the pipes may not be in an exact coaxial alignment. The inventive welding accessory substantially obviates this drawback and is characterized in that the welding accessory is provided with a number of supports which can move away in a radial direction from the central guide frame and with an equal number of auxiliary supports which at least operationally fill in the space between the supports.

A very favourable embodiment of the invention which realises a simple and yet very rigid support, is characterized in that the supports and the auxiliary supports have an at least substantially triangular or trapezoidal shape and that they have a radius of curvature which at least substantially corresponds with an internal radius of curvature of the pipes.

A favourable embodiment according to another aspect of the invention is characterized in that the edges of the supports and the auxiliary supports are provided with guiding means, for guiding neighbouring supports or auxiliary supports.

The previously mentioned known welding accessory is provided with a connecting point for feeding an inert gas into the compartment enclosed by the two mouldings, in order to prevent the inside of the pipes from oxidising during the welding operation. A further favourable embodiment of the invention is characterized in that an outside of the supports and the auxiliary supports are provided with a groove and that operationally the grooves form one continuous and at least substantially closed groove which passes underneath the ends to be welded together. Experimentally it has been shown that this closed groove forms a chamber which spontaneously and fast fills with the inert gas that is used in the TIG welding process which is commonly used for this type of welding and that in this way oxidation of the inside of the pipes can be prevented.

A further favourable embodiment of the invention is characterized in that the supports and the auxiliary supports are made of a ceramic material. The advantage is that this ceramic material is wear-resistant, that it is not affected by the welding process and that it expels practically no gasses during the welding process, which gasses might cause corrosion of the pipes.

Another favourable embodiment of the invention is characterized in that the central guide frame is provided with a hydraulic system, for pushing the supports in an outward direction. In this way, the supports can be pushed forceful against the insides of the pipes, for realising an optimal centring. A simple design for transfering the movement of a piston is characterized in that a lever linkage is mounted between the hydraulic system and a support.

The invention also relates to a method for butt-welding two pipe ends, according to which the pipe ends to be welded are slid from both sides over a welding accessory before the pipe ends are welded. The inventive method is characterized in that from a central guide frame, which is part of the welding accessory, a number of supports with a triangular or trapezial shape are moved outward in a radial direction and pushed against the inner walls of the pipe ends and that auxiliary supports with a triangular or trapezial shape are pulled or pushed between the supports, for filling in the spaces.

A favourable realization of the inventive method is characterized in that the auxiliary supports are pulled or pushed between the supports by spring means, which obviates the use of active means.

The invention will now be further explained with a reference to the following figures, in which:

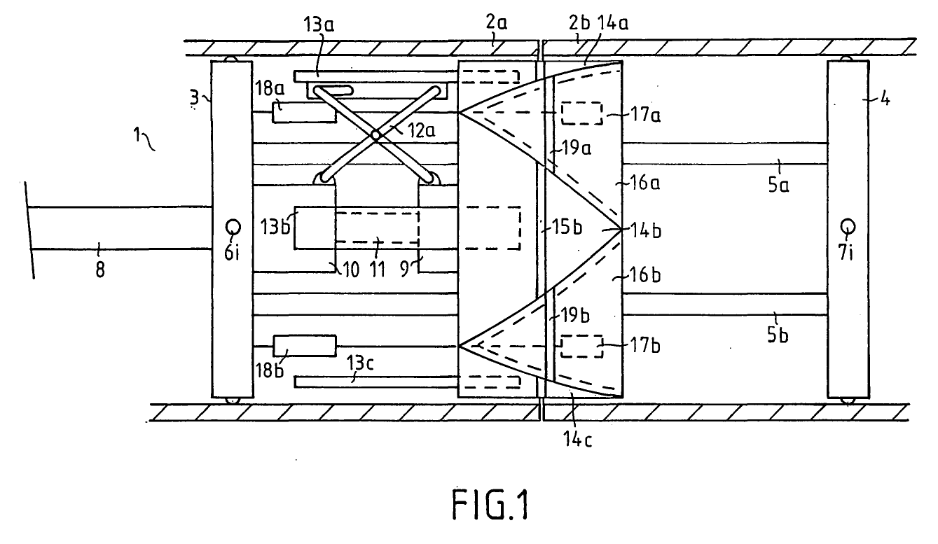

FIG. 1 represents a possible embodiment of the welding accessory in side view;

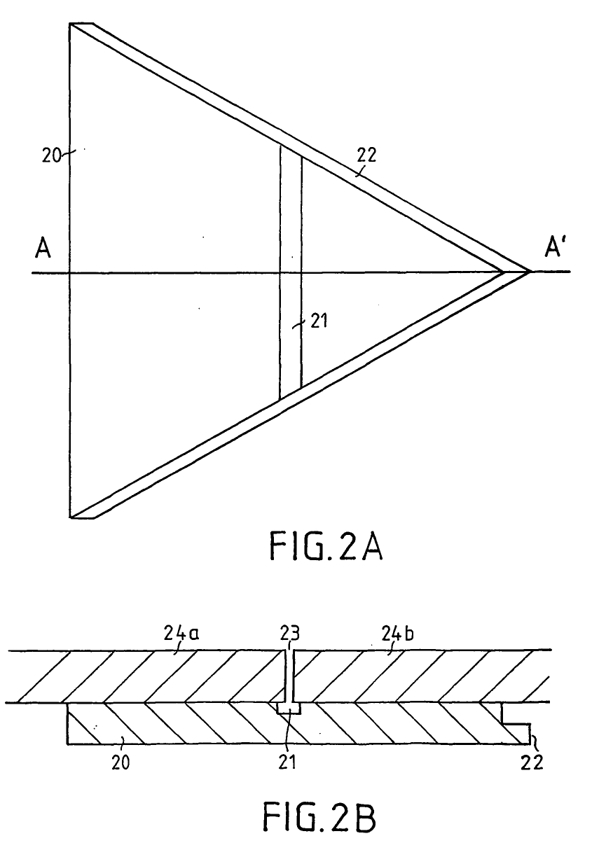

FIG. 2A schematically represents a main support in top view;

FIG. 2B schematically represents in cross section a main support, located underneath a weld to be made;

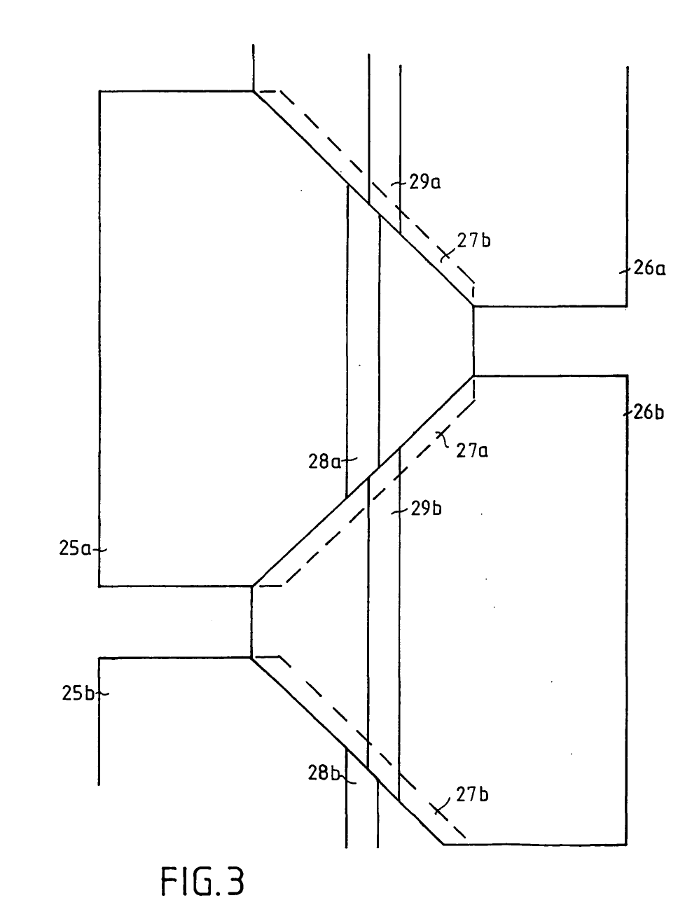

FIG. 3 schematically represents a system of trapezoidal shaped main supports and auxiliary supports;

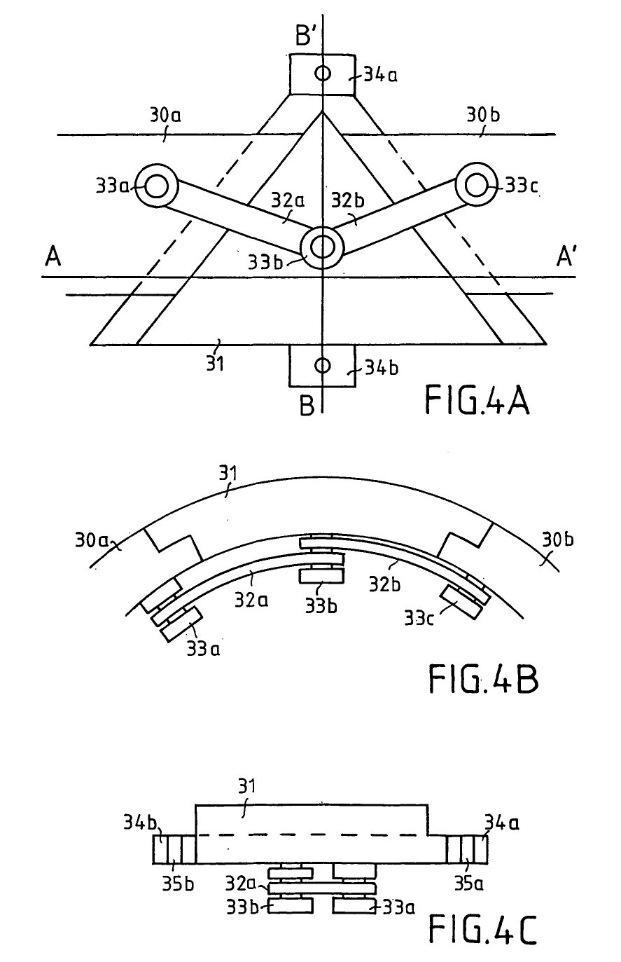

FIG. 4A schematically represents an auxiliary support with active steering means in bottom view;

FIG. 4B schematically represents this auxiliary support in a first cross section;

FIG. 4C schematically represents this auxiliary support in a second cross section.

FIG. 1 represents a possible embodiment of the welding accessory 1 according to the invention, shown in side view and located in two partly cut-away pipe ends 2a,2b. Welding accessory 1 consists of a central guide frame provided with two support disks 3,4, mutually coupled by four posts 5a,5b,5c,5d, of which in this figure only posts 5a,5b can be seen. The peripheries of support disks 3,4 are provided with balls 6i,7i, running in bearings or with wheels or with sliding surfaces, such that the central guide frame can easily be slid into pipe ends 2a,2b. A pipe 8 is coupled to support disk 3 for pulling out the central guide frame, once the pipes have been welded. In pipe 8 a hydraulic tube or a rod or a steel cable is placed, for moving a head 9 back and forth with a cylinder 11, which can slide in a bearing block 10. When head 9 moves back and forth, a mounting plate 13a is moved towards and from the pipe wall via a lever linkage 12a, well known in the art. In the embodiment shown here, four mounting plates 13a,13b, 13c,13d are simultaneously moved back and forth, each via an individual lever linkage 12a,12b,12c,12d, of which for clarity reasons only lever linkage 12a is shown. Welding accessory 1 is provided with four main supports 14a,14b, 14c,14d, which are mounted onto the four mounting plates 13a,13b,13c,13d, for example bonded, which can be moved in a manner described above, by moving head 9 towards pipe 8, in order to push the main supports against the insides of pipe ends 2a,2b. In this embodiment, main supports 14a,14b, 14c,14d have a triangular shape and they have an external radius of curvature that corresponds with the internal radius of curvature of the pipes. Preferably, they are made of a ceramic material, like silicon nitride, which has the known property that it expels practically no gasses when heated. Main supports 14a,14b,14c,14d can each be provided with a groove 15a,15b,15c,15d, which grooves are fitted precisely underneath the pipe ends 2a,2b to be welded.

Between the four main supports 14a,14b,14c,14d, four auxiliary supports 16a,16b,16c,16d are placed, here also with a triangular shape. On their bottom side they are provided with mounting plates 17a,17b,17c,17d, to which steel cables are connected which connect the auxiliary supports to support disk 3 via draw springs 18a,18b, 18c,18d. When main supports 14a,14b,14c,14d move towards the pipe walls, a space forms between the main supports, in which space the auxiliary supports 16a,16b,16c,16d are, pulled by pull springs 18a,18b,18c,18d. Instead of springs, one may of course also opt for an active solution, according to which the auxiliary supports 16a,16b,16c,16d are also connected to head 9 with lever linkages. Each auxiliary support 16a,16b,16c,16d can also be provided with a groove 19a,19b,19c,19d, which grooves are positioned such that, when main supports and auxiliary supports rest against the inner walls of pipe ends 2a,2b, the grooves 15a,19a,15b,19b,15c,19c,15d,19d form one uninterrupted groove, which will spontaneously be filled with an inert gas which is used during the welding process, as is known in the art, and which prevents corrosion of the inside of the weld. In order to obtain the effect it is necessary for the main supports 14a,14b,14c,14d to guide the auxiliary supports 16a,16b,16c,16d towards the pipe inner walls. For that purpose the edges of the main supports and of the auxiliary supports are provided with guiding means, like a tongue and groove. When the main supports 14a,14b,14c,14d and the auxiliary supports 16a,16b,16c,16d are made of a ceramic material, it is possible to clad the bottom side and the sides with a metal, with the exception of the sides provided with the guiding means. This makes the coupling to the mounting plates 13a,13b, 13c,13d and the mounting plates 17a,17b, 17c,17d easier and it reduces the risk of ceramic plates being lost by breakage, for example when the welding accessory is handled roughly.

FIG. 2A schematically represents a main support 20 in top view, before it is provided with a curvature. Main support 20 has a triangular shape and is provided with a groove 21, which is under operational conditions positioned underneath the weld. Moreover, the bottom side of main support 20 is provided with a rim 22, the thickness of which corresponds to half the thickness of main support 20 and the width of which is for example one centimetre. An auxiliary support, not shown here, co-operating with this main support has in a completely similar manner a rim on its topside, which rim rests on the rims of the neighbouring main supports. It is obvious then that, if two main supports move upward, out of the plane of the figure, the auxiliary support in between must follow.

FIG. 2B schematically represents a main support in a cross section according to line AA′ in FIG. 2A, provided with a groove 21, which is positioned underneath a weld 23 to be made, which weld will connect the pipe ends 24a,24b. Main support 20 is provided with a rim 22 on which operationally rests a complementary rim of an auxiliary support rests.

FIG. 3 schematically represents a system of trapezial shaped main supports 25a,25b, . . . and auxiliary supports 26a,26b, . . . For this embodiment too, the auxiliary supports will slide between the main supports when they separate, guided by the rims 27a,27b and the complementary rims on the co-operating main supports. When properly dimensioned, the grooves 28a,28b in the main supports and the grooves 29a,29b in the auxiliary supports will form a continuous groove, situated precisely underneath a weld to be made.

FIG. 4A schematically represents an auxiliary support with active steering means in bottom view, as seen from a main axis of the welding accessory, with two trapezial shaped main supports 30a,30b, between which an auxiliary support 31 can shift when the main supports move outward in a radial direction. In order to support this movement, main supports 30a,30b and auxiliary support 31 are mutually coupled by a hinged connection, consisting of two arms 32a,32b and three hinge points 33a,33b,33c. In a further obvious manner the auxiliary support 31 will be pulled actively between main supports 30a,30b and will be pushed out again when the main supports move inward. In the embodiment shown here, auxiliary support 31 is moreover provided with flanges 34a,34b, for connecting auxiliary support 31 with springs to the welding accessory if required. In that case a spring connects flange 34a preferably to support disk 3, while flange 34b may be connected by a spring with a connecting point near the main axis of the welding accessory.

FIG. 4B schematically represents this auxiliary support in a first cross section on a line AA′ in FIG. 4A, with main supports 30a,30b, auxiliary support 31, arms 32a,32b and hinge points 33a,33b,33c.

FIG. 4C schematically represents this auxiliary support in a second cross section on a line BB′ in FIG. 4A, with auxiliary support 31, flanges 34a,34b with holes 35a,35b, to which the springs can be connected if required, arm 32a and hinge points 33b,33c.

1. Welding accessory for supporting and centring two pipe ends of pipes to be butt-welded together, comprising a central guide frame, over which both pipe ends can slide, provided with support means and with pressure means for operationally pressing the support means against the pipe walls, characterized in that the welding accessory is provided with a number of supports which can move in a radial direction, away from the central guide frame and with an equal number of auxiliary supports which at least operationally fill in the space between the supports.

2. Welding accessory according to claim 1, characterized in that the supports and the auxiliary supports have an at least substantially triangular or trapezoidal shape and that they have a radius of curvature which at least substantially corresponds with an internal radius of curvature of the pipes.

3. Welding accessory according to claim 2, characterized in that spring means are provided, mounted between the a central guide frame and the auxiliary supports, for pulling or pushing the auxiliary supports between the supports.

4. Welding accessory according to claim 2 or 3, characterized in that the edges of the supports and the auxiliary supports are provided with guiding means, for guiding neighbouring supports or auxiliary supports.

5. Welding accessory according to claim 4, characterized in that the supports have a trapezoidal shape and the auxiliary supports have a triangular shape.

6. Welding accessory according to claim 4 or 5, characterized in that an outside of the supports and the auxiliary supports are provided with a groove and that operationally the grooves form one continuous and at least substantially closed groove which passes underneath the ends to be welded together.

7. Welding accessory according to claim 4 or 6, characterized in that the supports and the auxiliary supports are made of a ceramic material.

8. Welding accessory according to claim 7, characterized in that the supports and the auxiliary supports are made of silicon nitride.

9. Welding,accessory according to claim 4, 6 or 7, characterized in that the central guide frame is provided with a hydraulic system, for pushing the supports in an outward direction.

10. Welding accessory according to claim 9, characterized in that a lever linkage is mounted between the hydraulic system and a support.

11. Method for butt-welding two pipe ends, according to which the pipe ends to be welded are slid from both sides over a welding accessory before the pipe ends are welded, characterized in that from a central guide frame, which is part of the welding accessory, a number of supports with a triangular or trapezial shape are moved outward in a radial direction and pushed against the inner walls of the pipe ends and that auxiliary supports with a triangular or trapezial shape are pulled or pushed between the supports, for filling in the spaces.

12. Method according to claim 11, characterized in that the auxiliary supports are pulled or pushed between the supports by spring means.
